(19) United States
(12) Patent Application Publication
(10) Pub. No.: US 2017/0261091 A1
(43) Pub. Date: Sep. 14, 2017

(54) Device Reducing Drag Loss in an Automatic Transmission

(71) Applicant: ZF Friedrichshafen AG, Friedrichshafen (DE)

(72) Inventors: Markus Herrmann, Scheidegg (DE); Thilo Schmidt, Meckenbeuren (DE); Gerhard Martin, Langenargen (DE); Ahmed Mouhcine, Friedrichshafen (DE); Rainer Grundler, Bodman-Ludwigshafen (DE); Dirk Winkler, Kressbronn (DE); Valentine Vincent, Friedrichshafen (DE)

(21) Appl. No.: 15/199,114

(22) Filed: Jun. 30, 2016

(30) Foreign Application Priority Data
Mar. 8, 2016 (DE) 10 2016 203 774.9

(51) Int. Cl. F16H 57/04; F16K 31/00; F16H 61/48; F16H 61/02; F16H 61/14

(52) U.S. Cl. CPC F16H 57/0412; F16H 61/0265; F16H 61/14; F16H 61/48; F16K 31/002

(57) ABSTRACT

A drag torque reduction device for an automatic transmission includes a hydraulic controller with a diversion for excess cooling oil into an oil sump that is positioned upstream of a radiator relative to a flow of fluid to the radiator. The diversion includes a temperature-dependent, switchable aperture and a switching valve. The temperature-dependent, switchable aperture is configured to close above a temperature threshold. The switching valve is configured to close above a threshold pressure.

### FIELD OF THE INVENTION

The invention relates generally to a device for reducing the drag torque in an automatic transmission.

### BACKGROUND

The lubrication of transmission components and the cooling of components, in particular the shift elements of automatic transmissions of motor vehicles, is typically controlled in a manner dependent on torque and rotational speed, in order to provide the quantity of oil for lubricating and cooling transmission components that is in line with demand as much as possible. Due to the viscous properties of cooling oil, lower volume flows arise at low temperatures than at high temperatures, such that the quantity of oil supplied depends on temperature.

Strict fuel economy and emissions standards have resulted in the need to even further optimize the efficiency of automatic transmissions. Thereby, drag torque in particular is to be reduced in the range relevant for the consumption cycle. The NEDC (New European Driving Cycle) consumption cycle takes place in a limited range of operation, namely in the lower temperature range with moderate transmission loads.

DE 43 42 961 C1 discloses an arrangement for controlling the temperature of a hydraulic operating medium (working oil) for an automatically shifting transmission and a hydrodynamic torque converter with a converter feed line for the operating medium, for which a radiator for the heat dissipation of the operating medium with a radiator return line leading to the transmission and a control valve working as a function of the temperature of the operating medium are used, and a converter return line outgoing from the torque converter, a radiator supply line leading to the radiator and line for the control valve directly connected to the transmission are attached, whereas, at temperatures lower than a lower-temperature phase comprising a threshold value, it is both the case that the converter return line is shut off with respect to the radiator supply line and the line directly connected to the transmission is connected to a first of the lines attached to the control valve, while, at temperatures higher than an upper-temperature phase comprising the threshold value, it is both the case that the converter return line is connected to the radiator supply line and the line directly connected to the transmission is connected to a second of the lines attached to the control valve. It is thereby provided that the converter supply line is also connected to the control valve, that, in the lower-temperature phase, it is both the case that the converter return line is connected to the converter supply line and the line directly connected to the transmission is connected to the radiator supply line, and that, in the upper-temperature phase, the converter supply line is connected to the line directly connected to the transmission, such that a temperature-dependent radiator flow control is realized.

US 2014/0251745 A1 discloses a valve assembly for controlling the flow of oil through a radiator in a lubricating oil circuit of an electro-hydraulic transmission control unit, for which the radiator is connected to the lubrication oil supply through a parallel connection of at least two constant apertures and a hydraulically controlled switching valve, whereas, viewed in the direction of flow, a pressure relief valve is provided in front of such parallel connection. This switching valve may be hydraulically actuated by a solenoid with a control pressure in such a manner that an oil flow flowing through the switching valve to the radiator can be shut off, such that, at a low transmission load, the oil flow effectively flowing through the radiator for transmission lubrication is reduced to a predefined minimum amount.

### SUMMARY OF THE INVENTION

Exemplary aspects of the present invention provide a device for reducing the drag torque in an automatic transmission comprising multi-disk shift elements, a hydrodynamic torque converter and a converter clutch, which are controlled by a hydraulic controller with a radiator, which enables a reduction of the drag torque by reducing the quantity of cooling and lubricating oil and makes it possible to suspend the reduction of the quantity of cooling and lubricating oil when needed.

Accordingly, a device for reducing the drag torque in an automatic transmission comprising multi-disk shift elements, a hydrodynamic converter and a converter clutch, which are controlled by a hydraulic controller with a radiator, is proposed, which, in the hydraulic controller of the transmission in front of the radiator in the direction of flow to the radiator, realizes a diversion of the excess quantity of cooling oil into an oil sump, by a temperature-dependent, switchable aperture that closes above a temperature threshold and a switching valve that closes above a threshold pressure, which are switched in the sequence of “aperture—switching valve” or in the sequence of “switching valve—aperture” in a series.

If the temperature-dependent, switchable aperture and the switching valve are switched in the sequence of “aperture—switching valve” in a series, it is preferably provided that, in the direction of flow to the oil sump behind the switching valve—thus at the end of the switching valve—a constant aperture is arranged, at which a pressure gradient depending on the volume flow is adjusted, such that the switching valve is closed if a compressive force acting on a valve slide of the switching valve that arises through the backflow at the constant aperture is greater than a spring force acting counter to the closing direction of the switching valve likewise on the valve slide of the switching valve.

If the temperature-dependent, switchable aperture and the switching valve are switched in the sequence of “switching valve—aperture” in a series, it is preferably provided that, at the end of the switching valve at the temperature-dependent, switchable aperture, a pressure gradient depending on the volume flow and the temperature is adjusted, such that the switching valve is closed if the compressive force acting on a valve slide of the switching valve that arises through the backflow at the temperature-dependent, switchable aperture is greater than the spring force acting counter to the closing direction of the switching valve likewise on the valve slide of the switching valve.

Through the design in accordance with exemplary aspects of the invention, in the lower temperature range with moderate transmission loads (i.e., in the NEDC consumption cycle), the oiling quantities of the multi-disks of the shift elements is reduced, which, in an advantageous manner, results in a reduction in the drag torques caused by the shift elements.

### BRIEF DESCRIPTION OF THE DRAWINGS

In the following, the invention is more specifically illustrated as an example on the basis of the attached figures. The following is shown:

FIG. 1: A system pressure/oil temperature diagram to illustrate the areas of minimum lubrication and cooling;

FIG. 2: A schematic presentation of a first exemplary embodiment of the invention; and

FIG. 3: A schematic presentation of a second exemplary embodiment of invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

Hydraulic controllers for automatic transmissions comprising a hydrodynamic converter and a converter clutch are well-known to the specialist, such that, within the framework of the following description of figures, only the components relevant to the invention are described and explained.

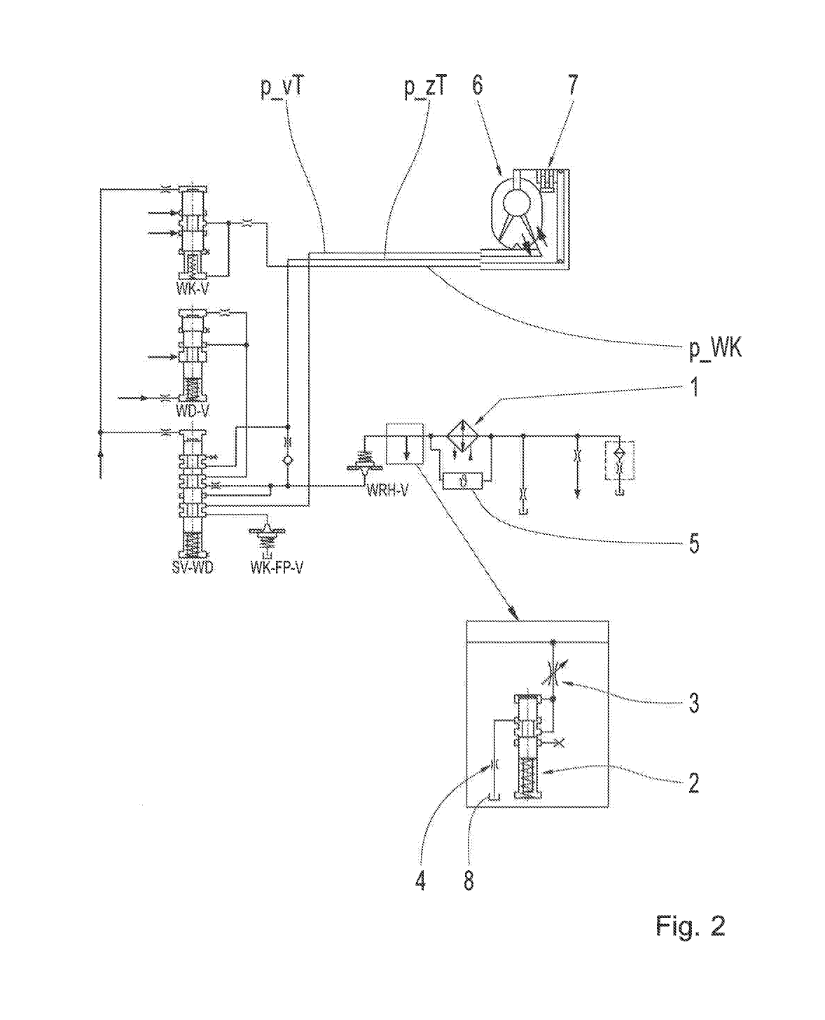

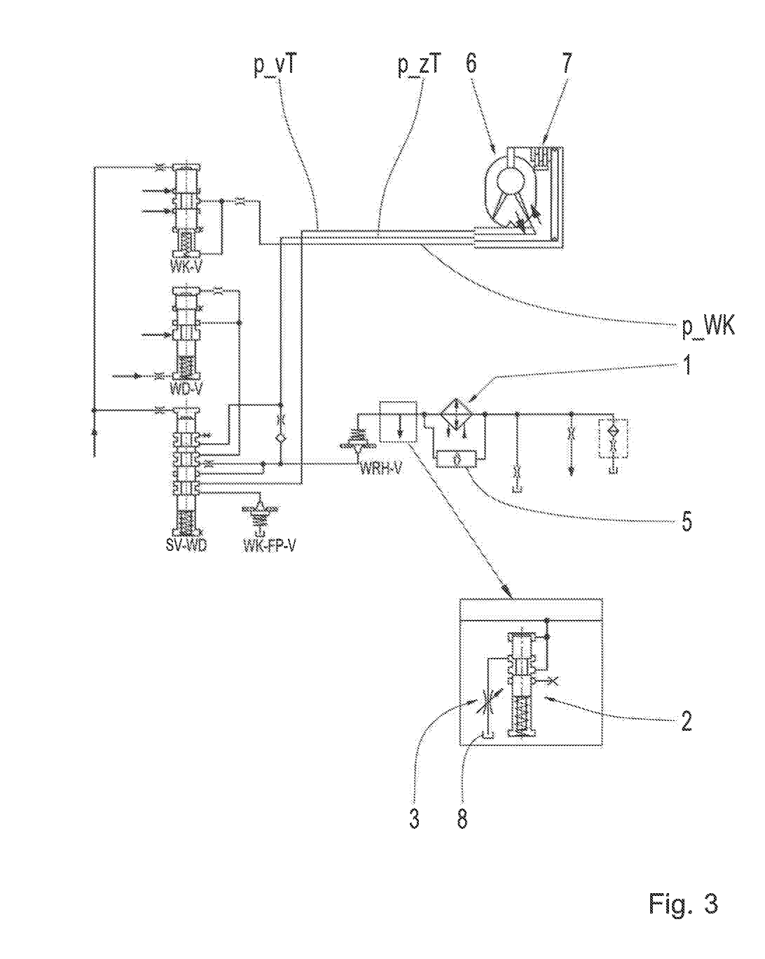

FIGS. 2 and 3 show a hydraulic controller for an automatic transmission comprising a hydrodynamic converter 6 and a converter clutch 7. The exemplary embodiments shown differ with respect to the varying arrangements and designs of the device in accordance with aspects of the invention. In FIGS. 2 and 3, a converter clutch valve is designated with WK-V, a converter pressure valve is designated with WD-V, a converter switching valve is designated with SV-WD, a converter base point valve is designated with WK-FP-V and a converter retaining valve is designated with WRH-V. Furthermore, a radiator is shown with 1 and a radiator bypass is shown with 5; it is ensured through these that the oil is not directed through the radiator 1 at low temperatures. Thereby, the converter ring inlet pressure is designated with p_zT, the converter ring outlet pressure is designated with p_vT and the converter clutch pressure is designated with p_WK.

According to a first exemplary embodiment of the invention and with reference to FIG. 2, a device for reducing the drag torque in an automatic transmission comprising a hydrodynamic converter 6 and a converter clutch 7 is proposed, with which, in the hydraulic controller of the transmission in front of the radiator 1 in the direction of flow to the radiator 1, a diversion of the excess quantity of cooling oil into an oil sump 8 is provided, by a temperature-dependent, switchable aperture that closes above a predetermined temperature threshold Θ_SP and a switching valve 2 that closes above a predetermined pressure threshold p_Sys_SP, which are switched in the sequence of “aperture 3—switching valve 2” in a series.

At temperatures that fall below this predetermined temperature threshold Θ_SP, the temperature-dependent, switchable aperture 3 is open. Furthermore, at low pressures that fall below the predetermined pressure p_Sys_SP, the switching valve 2 is opened, and is closed above p_Sys_SP, such that, with an open switching valve 2, the deviated oil flows into the oil sump 8.

The switching valve 2 is opened through the amount of pressure in the inlet at the switching valve 2 coming from the temperature-dependent, switchable aperture 3, that is, if the compressive force acting on the valve slide of the switching valve 2 that arises through such inlet pressure is less than a spring force acting counter to the closing direction of the switching valve 2, which also acts on the valve slide of the switching valve 2.

At the end of the switching valve 2 at the oil sump 8, a constant aperture 4 is provided, at which a pressure gradient depending on the volume flow is adjusted. The switching valve 2 is closed, if the compressive force acting on the valve slide of the switching valve 2 that arises through the backflow at the constant aperture 4 is greater than the spring force counter to the closing direction of the switching valve 2 that is also acting on the valve slide of the switching valve 2. The switching valve 2 is now held in the closed state by the pressure prevailing in the inlet of the switching valve 2. If the temperature-dependent, switchable aperture 3 now closes, the switching valve 2 has no function, such that the spring force of the valve slide of the switching valve 2 acting counter to the closing direction of the switching valve 2 moves into its “switching valve open” resting position.

As a result, a minimum lubrication and cooling is achieved at temperatures up to a maximum of Θ_SP or pressures up to a maximum of p_Sys_SP. At temperatures that exceed Θ_SP and pressures that exceed p_Sys_SP, no diversion of oil is achieved; the volume flow to the radiator 1 corresponds to the normal level corresponding to the current system pressure. The temperature-dependent, switchable aperture 3 may be designed, for example, as a bimetal aperture.

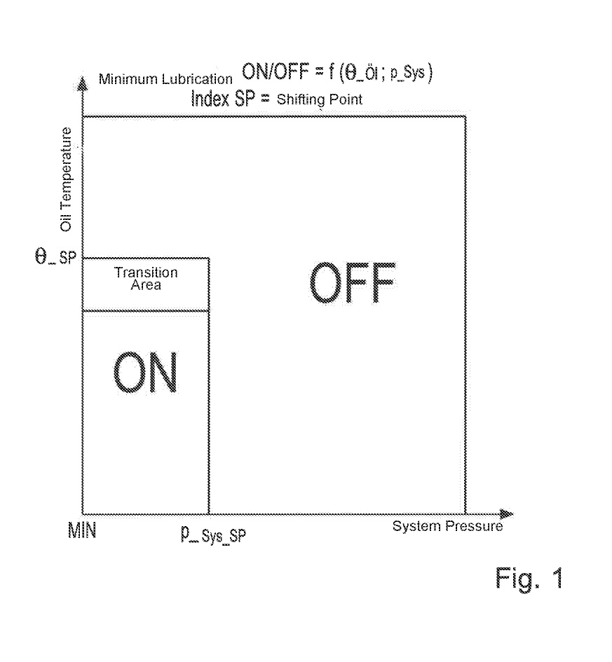

Through the concept in accordance with exemplary aspects of the invention, a minimum lubrication and cooling at low temperatures and low system pressures is ensured, since, at low temperatures that fall below a predetermined temperature threshold Θ_SP, the temperature-dependent, switchable aperture 3 remains open and, at low pressures that fall below a predetermined pressure p_Sys_SP, the switching valve 2 remains open. This is illustrated with reference to FIG. 1.

It is thereby clear that, at temperatures up to a maximum of Θ_SP and pressures up to a maximum of p_Sys_SP, the minimum lubrication and cooling is provided through the constant aperture 4. At temperatures that exceed Θ_SP, the volume flow increases. Furthermore, at a system pressure that exceeds p_Sys_SP, the oil flow increases, in order to not cause any damages to the transmission components at high transmission loads and low oil temperatures, and in order to ensure a sufficient oil supply of the shift elements for shifting. Preferably, the temperature-dependent, switchable aperture 3 and the switching valve 2 are designed in such a manner that, with a closed temperature-dependent, switchable aperture 3 or with a closed control valve 2, the volume flow to the radiator 1 corresponds to the normal level corresponding to the current system pressure.

As an alternative to the sequence of “aperture 3—switching valve 2”, the aperture 3 and the switching valve 2 may be arranged in the sequence of “switching valve 2—aperture 3,” as illustrated by FIG. 3. With this arrangement, the temperature-dependent, switchable aperture 3 simultaneously takes over the function of the constant aperture 4 provided in FIG. 2.

The switching valve 2 is opened through the amount of the inlet pressure of the switching valve 2, that is, if the compressive force acting on the valve slide of the switching valve 2 that arises through such inlet pressure is less than the spring force acting counter to the closing direction of the switching valve 2, which also acts on the valve slide of the switching valve 2.

The temperature-dependent, switchable aperture 3 is now arranged at the end of the switching valve 2 at the oil sump 8. At the aperture 3, a pressure gradient is adjusted, which depends on both the volume flow and the temperature. The switching valve 2 is closed, if the compressive force acting on the valve slide of the switching valve 2 that arises through the backflow at the constant aperture 4 is greater than the spring force acting counter to the closing direction of the switching valve 2. The switching valve 2 is held in the closed state by the pressure prevailing in the inlet of the switching valve 2. If the temperature-dependent, switchable aperture 3 now closes, the valve slide of the switching valve 2 moves into its “switching valve closed” final position.

As a result, a minimum lubrication and cooling is also achieved here at temperatures up to a maximum of Θ_SP or pressures up to a maximum of p_Sys_SP. At temperatures that exceed Θ_SP and pressures that exceed p_Sys_SP, no diversion of oil is achieved; the volume flow to the radiator 1 corresponds to the normal level corresponding to the current system pressure. Here as well, the temperature-dependent, switchable aperture 3 may be designed, for example, as a bimetal aperture.

Modifications and variations can be made to the embodiments illustrated or described herein without departing from the scope and spirit of the invention as set forth in the appended claims.

### REFERENCE SIGNS

1 Radiator
2 Switching valve
3 Temperature-dependent, switchable aperture
4 Constant aperture
5 Radiator bypass
6 Converter
7 Converter clutch
8 Oil sump
p_Sys System pressure
p_Sys_SP Pressure threshold
p_vT Converter ring outlet pressure
p_zT Converter ring inlet pressure
θ_Öl Oil temperature
θ_SP Temperature threshold
SV-WD Converter switching valve
WD-V Converter pressure valve
WRH-V Converter retaining valve
WK-FP-V Converter base point valve
WK-V Converter clutch valve

1-4. (canceled)

5. A drag torque reduction device for an automatic transmission, comprising:
a plurality of multi-disk shift elements;
a hydrodynamic torque converter:
a converter clutch; and
a hydraulic controller with a radiator, the hydraulic controller operable to control the plurality of multi-disk shift elements, the hydrodynamic torque converter and the converter clutch, the hydraulic controller having a diversion for excess cooling oil into an oil sump, the diversion positioned upstream of the radiator relative to a flow of fluid to the radiator, the diversion comprising a temperature-dependent, switchable aperture and a switching valve, the temperature-dependent, switchable aperture configured to close above a temperature threshold, the switching valve configured to close above a threshold pressure, the diversion configured such that the temperature-dependent, switchable aperture and the switching valve are arranged in a sequence of the temperature-dependent, switchable aperture then the switching valve in series.

6. The drag torque reduction device of claim 5, wherein the hydraulic controller further comprises a constant aperture that is positioned downstream of the switching valve relative to a flow of fluid to the oil sump, the constant aperture configured to adjust a pressure gradient depending upon a volume flow through the constant aperture such that the switching valve is closed when a compressive force acting on a valve slide of the switching valve is greater than a spring force acting on the valve slide of the switching valve, the compressive force arising through a backflow at the constant aperture.

7. A drag torque reduction device for an automatic transmission, comprising:
a plurality of multi-disk shift elements;
a hydrodynamic torque converter;
a converter clutch; and
a hydraulic controller with a radiator,
a hydraulic controller with a radiator, the hydraulic controller operable to control the plurality of multi-disk shift elements, the hydrodynamic torque converter and the converter clutch, the hydraulic controller having a diversion for excess cooling oil into an oil sump, the diversion positioned upstream of the radiator relative to a flow of fluid to the radiator, the diversion comprising a temperature-dependent, switchable aperture and a switching valve, the temperature-dependent, switchable aperture configured to close above a temperature threshold, the switching valve configured to close above a threshold pressure, the diversion configured such that the temperature-dependent, switchable aperture and the switching valve are arranged in a sequence of the switching valve then the temperature-dependent, switchable aperture in series.

8. The drag torque reduction device of claim 7, wherein a pressure gradient depending on the volume flow and the temperature is adjustable at an end of the switching valve at the temperature-dependent, switchable aperture such that the switching valve is closed when a compressive force acting on a valve slide of the switching valve is greater than a spring force acting on the valve slide of the switching valve, the compressive force arising through a backflow at the temperature-dependent, switchable aperture.
